(19) United States
(12) Patent Application Publication
(10) Pub. No.: US 2017/0262053 A1
(43) Pub. Date: Sep. 14, 2017

(54) DISPLAY APPARATUS

(71) Applicant: SAMSUNG ELECTRONICS CO., LTD., Suwon-si (KR)

(72) Inventor: In-cheun NOH, Busan (KR)

(21) Appl. No.: 15/405,478

(22) Filed: Jan. 13, 2017

(30) Foreign Application Priority Data
Mar. 10, 2016 (KR) 10-2016-0029075

(51) Int. Cl. G06F 3/01; F16M 11/14; F16M 11/18

(52) U.S. Cl. CPC G06F 3/013; F16M 11/18; F16M 11/14

(57) ABSTRACT

A display apparatus is provided, the display apparatus includes a main body including a display configured to display an image; and an angle adjusting apparatus configured to rotate the main body, wherein the angle adjusting apparatus includes a substantially sphere-shaped driving ball configured to support the main body; and at least one rotation unit configured to rotate the driving ball with reference to a center point of the driving ball.

### CROSS-REFERENCE TO RELATED APPLICATION

This application is based on and claims priority under 35 U.S.C. §119 to Korean Patent Application No. 10-2016-0029075, filed on Mar. 10, 2016, in the Korean Intellectual Property Office, the disclosure of which is incorporated by reference herein in its entirety.

### BACKGROUND

Field

The present disclosure relates generally to a display apparatus, and for example, to a display apparatus of which an angle may be manipulated based on a user's gaze.

Description of Related Art

In general, a display apparatus such as a TV, a monitor and the like is arranged in a fixed state in a certain space. A user could recognize a content image being displayed through the display apparatus by viewing the display apparatus in a state where he/she is spaced from the display apparatus at a certain distance.

A display surface of the display apparatus may be realized as a curved surface, but in many cases, it is realized as a plane surface. Therefore, in recognizing a content image being displayed on the display apparatus, a viewing angle of the display apparatus is limited. For example, the user could most easily recognize the content image when the front surface where the content image is displayed in the display apparatus and the user's gaze is vertical to each other.

However, if the user viewing the display apparatus changes his/her posture or moves, the user's gaze towards the display apparatus is changed, and thus the user may not easily recognize the content image being displayed on the display apparatus.

SUMMARY

The present disclosure provides a display apparatus having an angle that may be manipulated based on a user's gaze.

According to an example embodiment of the present disclosure, a display apparatus is provided, the display apparatus including a main body including a display configured to display an image; and an angle adjusting apparatus configured to rotate the main body and includes a sphere-shaped driving ball configured to support the main body; and at least one rotation apparatus configured to rotate the driving ball with reference to a center point of the driving ball.

### BRIEF DESCRIPTION OF THE DRAWINGS

The above and/or other aspects, features and attendant advantages of the present disclosure will be more apparent and readily understood from the following detailed description, taken in conjunction with the accompanying drawings, in which like reference numerals refer to like elements, and wherein:

FIG. 1 is a diagram illustrating an appearance of an example display apparatus according to an example embodiment of the present disclosure;

FIG. 2 is a block diagram illustrating an example control flow of a main body and an angle adjusting apparatus illustrated in FIG. 1;

FIG. 3 is an enlarged front view of a portion of the example display apparatus of FIG. 1, illustrating components of the example angle adjusting apparatus;

FIG. 4 is a plan view illustrating a portion of the example angle adjusting apparatus illustrated in FIG. 3;

FIG. 5 is a diagram illustrating a first rotation unit in FIG. 3 moving downwards and to a spaced position spaced from a driving ball;

FIGS. 6A and 6B are diagrams illustrating the main body being tilted towards a right side by driving of the angle adjusting apparatus, according to an example embodiment of the present disclosure;

FIGS. 7A and 7B are diagrams illustrating the main body being tilted towards a left side by driving of the angle adjusting apparatus, according to an example embodiment of the present disclosure;

FIGS. 8A and 8B are diagrams illustrating the main body being tilted towards a front direction by driving of the angle adjusting apparatus, according to an example embodiment of the present disclosure;

FIGS. 9A and 9B are diagrams illustrating the main body being tilted towards a rear direction by driving of the angle adjusting apparatus, according to an example embodiment of the present disclosure;

FIGS. 10A and 10B are diagrams illustrating the main body being rotated in a clockwise direction by driving of the angle adjusting apparatus, according to an example embodiment of the present disclosure;

FIGS. 11A and 11B are diagrams illustrating the main body being rotated in a counterclockwise direction by driving of the angle adjusting apparatus, according to an example embodiment of the present disclosure;

FIG. 12A is an enlarged view of the driving ball and a rotation disk of the angle adjusting apparatus, according to another example embodiment of the present disclosure;

FIG. 12B is a cross-sectional view of the driving ball and the rotation disk cut along line I-I illustrated in FIG. 12A;

FIG. 13A is an enlarged view of the driving ball and the rotation disk of the angle adjusting apparatus, according to another example embodiment of the present disclosure;

FIG. 13B is a cross-sectional view of the driving ball and the rotation disk cut along line II-II illustrated in FIG. 13A; and

FIG. 14 is a flowchart illustrating an example process where an angle of the main body is automatically adjusted based on a user's gaze by driving of the angle adjusting apparatus, according to an example embodiment of the present disclosure.

### DETAILED DESCRIPTION

Hereinafter, various example embodiments of the present disclosure will be explained in greater detail with reference to the drawings attached. The embodiments explained hereinafter will be explained based on the embodiments that are suitable for understanding the technical characteristics of the present disclosure, and the technical characteristics of the present disclosure are not limited by the embodiments, but exemplify that the present disclosure may be realized as in the embodiments being explained.

Therefore, the present disclosure may be modified in various ways with the technical scope of the present disclosure, and such modified embodiments will be within the technical scope of the present disclosure. Further, regarding the reference numerals disclosed in drawings attached to help understand the embodiments to be explained hereinafter, like reference numerals refer to like components.

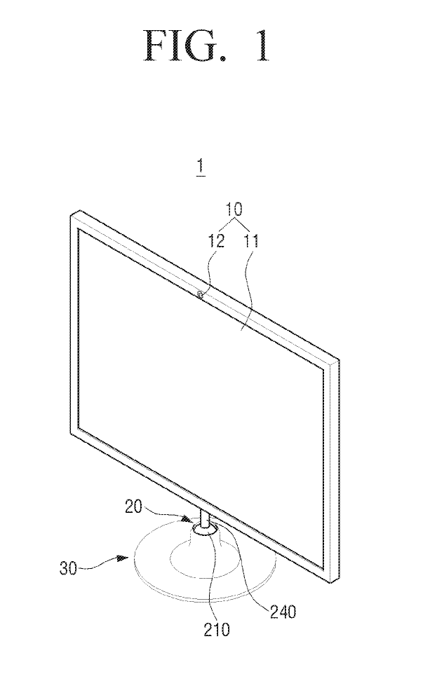

FIG. 1 is a diagram illustrating an appearance of an example display apparatus 1 according to an example embodiment of the present disclosure.

The display apparatus 1 according to an embodiment of the present disclosure may be realized as various types of electronic apparatuses such as TV, electronic bulletin board, electronic table, large format display (LFD), smart phone, tablet, desktop PC, notebook and the like, but is not limited thereto.

Referring to FIG. 1, the display apparatus 1 may include a main body 10, an angle adjusting apparatus 20, and a stand housing 30.

The main body 10 may include a display 11 disposed on a front surface of the display apparatus 1 to display various contents images, and a camera 12 disposed on an upper side of the display 11 to photograph towards a front direction.

The display 11 may include any one of a liquid crystal display (LCD) panel, a light emitting diode (LED) panel, and an organic light emitting diode (OLED) panel, and the panel may be a thin film type display panel of which the weight has been lightened. It will be understood that the display is not limited to these examples.

The camera 12 is configured to photograph a user located in front of or on the periphery of the display apparatus 1. An image photographed by the camera 12 may be provided to a controller (not illustrated) disposed inside the display apparatus 1. The controller may analyze the image and analyze a user's gaze. The controller may measure an angle that the user's gaze and the display 11 form, and measure a tilted degree of the user's gaze comprising of a line connecting two pupils in accordance with the tilt of the user's face. Explanation on photographing the user's gaze using the camera 12 and on an automatic angle adjustment method of the main body 10 will be described in greater detail below.

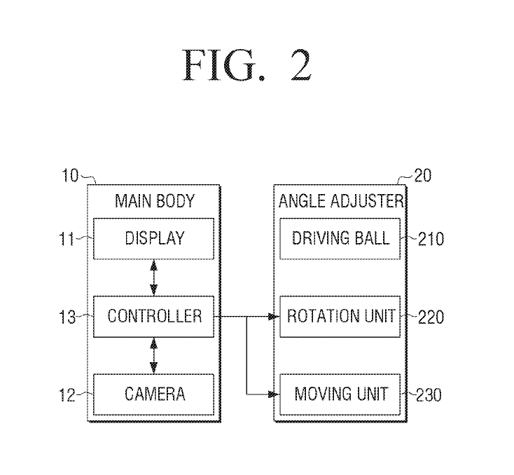

The angle adjusting apparatus (sometimes referred to herein as the “angle adjuster”) 20 is a configuration capable of adjusting the angle of the main body 10 by tilting or rotating the main body 10. The angle adjuster 20 may include a driving ball 210, a rotation unit (220 of FIG. 2), a moving unit (230 of FIG. 2) and a connection member 240, etc.

Further, the angle adjuster 20 may be supplied with driving power through the main body 10, or may be directly connected to a separate power cable (not illustrated) configured to receive power from outside.

One end of the connection member 240 may be coupled to the main body 10, and the other end of the connection member 240, opposite to the one end of the connection member 240, may be connected to the sphere-shaped driving ball 210.

The driving ball 210 may rotate in a state where it is connected to the main body 10 through the connection member 240, and may thus change the angle of the main body 10. The method for adjusting the angle of the main body 10 through the driving ball 210 will be explained in detail later on.

As illustrated in FIG. 1, the display apparatus 1 may include a stand housing 30 configured to support the display apparatus 1.

The stand housing 30 is configured to stand on the ground in a space where the display apparatus 1 is disposed, and may be configured such that the surface area of its a lower end touching the ground is greater than the surface area of its upper end in order to withstand load of the display apparatus 1.

Inside the stand housing 30, some of the components of the angle adjuster 20 may be disposed. For example, by arranging the rotation unit 220, the moving unit 230 and some of the components of the driving ball 210 inside the stand housing 30, it is possible to enhance the aesthetic appearance of the display apparatus 1.

Although explanation will be made with reference to an embodiment, where the stand housing 30 configured to stand on the ground supports the angle adjuster 20, and the driving ball 210 of the angle adjuster 20 supports the lower end of the main body 10, according to an embodiment of the present disclosure, the angle adjuster and the stand housing may also be applied to a wall-mounted display apparatus, where a rear surface of the main body and the driving ball are coupled to each other, and the stand housing that supports the driving ball is attached to a wall surface.

FIG. 2 is a block diagram illustrating an example control flow of the main body 10 and the angle adjuster 20.

Referring to FIG. 2, as aforementioned, the main body 10 may further include a controller 13, and the controller 13 may control operations of the camera 12 and the display 11 of the main body 10.

When a user's image photographed by the camera 12 is received, the controller 13 parses a plurality of image frames in pixel or pixel block units to detect a direction of a user's gaze. For example, the controller 13 may detect a location coordinate of the user's pupil within one image frame. The controller 13 may detect, within the next image frame, a location coordinate of the same object, that is, the user's pupil. The controller 13 may compare the position coordinates detected within a plurality of sequential image frames to estimate in which direction the user's gaze heads towards, and determine the angle that a reference position of the surface of the display 11 and the user's gaze form in consideration of the total size of the display 11, user's position, user's height or eye height. Here, the reference position may be set to be a central point of the display 11, but there is no limitation thereto, and thus may vary depending on the settings of the user or the manufacturing manager.

When the angle that the user's gaze and the display 11 form is detected, the controller 13 may determine a rotating direction and an angle of the main body 10 that would keep the angle under certain conditions. Here, the condition may refer, for example, to an angle condition or a rotation condition that enables the user to recognize the content image of the display apparatus 1 more easily.

Further, the controller 13 may control operations of the angle adjuster 20, particularly, control driving of the rotation unit 220 and the moving unit 230. By such control of the controller 13 to drive the rotation unit 220 and the moving unit 230 of the angle adjuster 20, the driving ball 210 may be rotated, and as the driving ball 210 rotates, the main body 10 may be rotated to face the user's gaze.

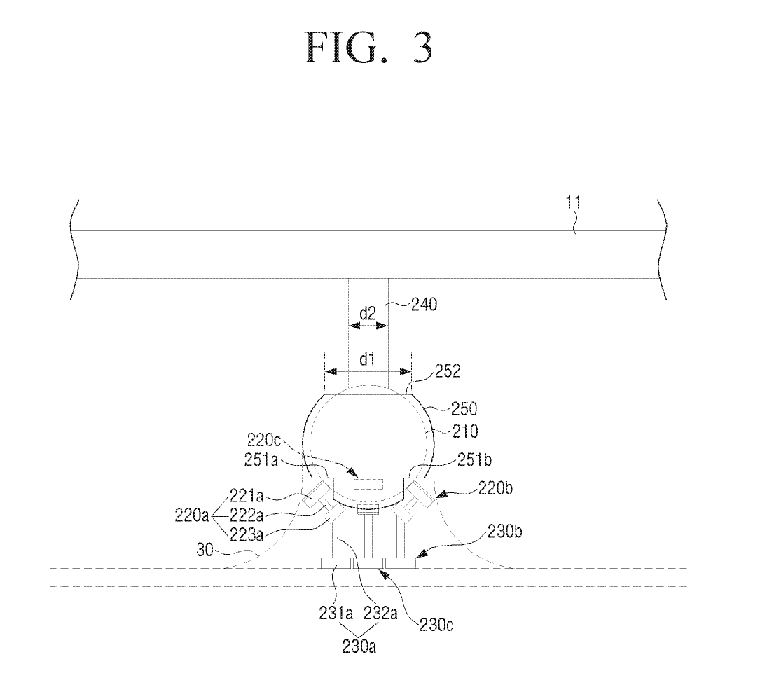

FIG. 3 is an enlarged front view of a portion of the display apparatus of FIG. 1, illustrating various components of the example angle adjuster 20.

In order to illustrate the components of the angle adjuster 20, in FIG. 3, the stand housing 30 is illustrated in a transparent state using dotted lines, and the components of the angle adjuster 20 disposed inside the stand housing 30 are illustrated.

Hereinafter, referring to FIG. 3, configurations of the angle adjuster 20 will be explained in greater detail.

The angle adjuster 20 may include the driving ball 210, the rotation unit 220, the moving unit 230, the connection member 240 and a capsule member 250.

As aforementioned, the driving ball 210 has a substantially spherical shape, and may be connected to the display 11 through the connection member 240 coupled to one side of it, and by rotating with reference to its center point, tilt or rotate the main body 10 connected to it.

The capsule member 250 may be of a substantially sphere-shape, having space where the driving ball 210 may be accommodated therein, and may cover a portion of an outer surface of the driving ball 210. Further, the capsule member 250 may support the driving ball 210 disposed inside thereof, and prevent the rotating driving ball 210 from deviating from the angle adjuster 20.

Further, a diameter of an inner circumference of the capsule member 250 may correspond to a diameter of an outer circumference of the driving ball 210, and accordingly, inside the capsule member 250, the driving ball 210 may rotate with reference to the center point of the driving ball 210 without changing positions.

Further, since the driving ball 210 may rotate in a state where it is in contact with the inner circumference of the capsule member 250, the inner circumference of the capsule member 250 may be coated with a material having a low coefficient of friction in relationship with the outer surface of the driving ball 210. This may prevent interference of friction between the outer surface of the driving ball 210 and the inner circumference of the capsule member 250, thereby facilitating rotation of the driving ball 210 inside the capsule member 250.

Further, as illustrated in FIG. 3, the capsule member 250 may include an opening 252 formed at one side thereof.

A portion of the driving ball 210 and the connection member 240 may be disposed in an inner space of the opening 252. Therefore, the portion of the driving ball 210 disposed inside the capsule member 250 may be exposed outside of the capsule member 250 through the opening 252, and as the connection member 240 coupled to the driving ball 210 protrudes outside of the capsule member 250, the connection member 240 and the main body 10 may be coupled to each other.

Further, a diameter dl of the opening 252 is configured to be greater than a diameter d2 of the connection member 240, thereby providing space where the connection member 240 may rotate inside the opening 252 as the driving ball 210 rotates, thereby rotating the main body 10.

Therefore, in the inner circumference of the opening 252, the connection member 240 may be interfered by rotation of the connection member 240 as the driving ball 210 rotates, and thus, by changing the diameter of the opening 252, a radius of rotation of the connection member 240 may be limited. For example, in the case of increasing the diameter of the opening 252, when a rotation range of the main body 10 is increased and the diameter of the opening 252 is reduced, the rotation range of the main body 10 may be reduced. However, the diameter of the opening 252. may be configured to be smaller than the diameter of the driving ball 210 so that the capsule member 250 supports the driving ball 210 and prevents the driving ball 210 from deviating.

In addition, the capsule member 250 may be disposed inside the stand housing 30, and may be integrally formed with the stand housing 30.

The rotation unit 220 may be disposed at one side of the driving ball 210 to apply rotary force to the driving ball 210 so that the driving ball 210 may rotate with reference to the center point of the driving ball 210.

Further, the rotation unit 220 may be disposed at the other side of the driving ball 210 that is opposite to the one side of the driving ball 210 to which the connection member 240 is coupled, in order to transmit the rotary force to the driving ball 210 efficiently.

The rotation unit 220 may be configured as a single unit or as a plurality of units, and the plurality of rotation units 220 may be disposed at certain intervals or radially around the driving halls 210.

In the case where the angle adjuster 20 includes a plurality of rotation units 220, the plurality of rotation units 220 may include angular rotation axes that are not parallel to one another, and the plurality of rotation units 220 may each rotate with reference to its respective rotation axis.

Accordingly, the plurality of rotation units 220 may apply rotary force to the drive balls 210 in different directions. This is for rotating the drive ball 210 in various directions through the plurality of rotation units 220, and the rotation method of the drive ball 210 through the plurality of rotation units 220 will be explained in detail later on.

In FIG. 3, a first to third rotation unit 220a, 220b, 220c are illustrated as being disposed below the driving balls 210 at certain intervals as an example of the plurality of driving units 220, for convenience of explanation, but the number and arrangement structure of the rotation units 220 may vary depending on the method and direction which the driving ball 210 is rotated through the rotation units 220.

Hereinafter, common components of the first to third rotation unit 220a, 220b, 220c will be explained with reference to the first rotation unit 220a, and explanation on the components of the second and third rotation unit 220b, 220c overlapping with the first rotation unit 220a will be omitted.

The first rotation unit 220a may include a first rotation disk 221a, a first rotation axis 222a, and a first rotation motor 223a.

The first rotation disk 221a may rotate with reference to the first rotation axis 222a in a state where it is in contact with the outer surface of the driving ball 210, thereby directly transmitting rotary force to the driving ball 210 by friction force against the driving ball 210. Further, the driving ball 210 may be rotated by the friction force against the first rotation disk 221a, and may thus rotate in a direction opposite to the rotating direction of the first rotation disk 221a.

The first rotation disk 221a may have a shape of a wheel or a sphere that may rotate with reference to its center, and in an embodiment of the present disclosure, the first rotation disk 221a is illustrated as having the shape of a cylindrical wheel, as an example.

As the first rotation disk 221a rotates in a state where it is in contact with the driving ball 210, the driving ball 210 may rotate in a direction opposite to the rotating direction of the first rotation disk 221a.

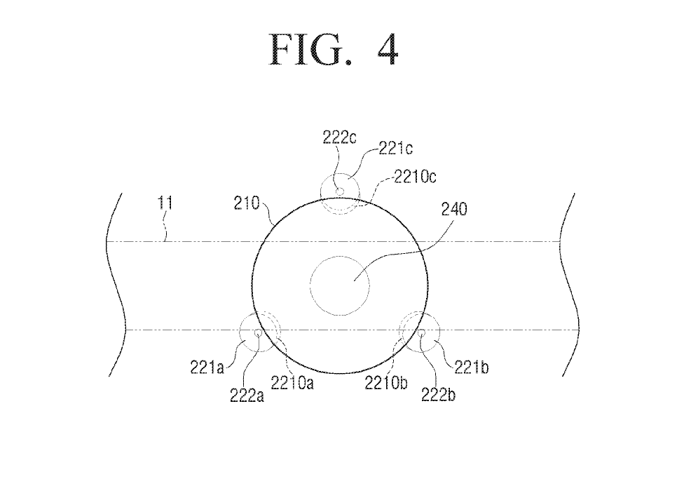

Specifically, the first rotation disk 221a may include a first rim (2110a of FIG. 4) provided along a wheel-shaped edge, and as the outer surface of the driving ball 210 contacts the rotating first rim 2110a, the driving ball 210 may be rotated by the friction force.

For this purpose, the first rim 2110a may be made of a material having a great coefficient of friction against the outer surface of the driving ball 210. For example, the outer surface of the driving ball 210 may be made of a resin material such as rubber, and accordingly, the first rim 2110a may be made of a metal material having a great coefficient of friction in the relationship with the resin material. Further, the outer surface of the driving ball 210 may be made of a metal material, and accordingly, the first rim 2110a may be made of a resin material such as rubber.

To the center of the first rotation disk 221a, one end of the first rotation axis 222a may be coupled, and to the other end of the first rotation axis 222a that is opposite to the one end connected to the first rotation disk 221a, a first rotation motor 223a may be coupled.

Therefore, through the driving force in the first rotation motor 223a, the first rotation disk 221a may rotate with reference to the first rotation axis 222a.

The first rotation motor 223a may rotate the first rotation disk 221a in a clockwise direction or in a counterclockwise direction with reference to the first rotation axis 222a according to the control of the controller 13, and this may also change the rotating direction of the driving ball 210. Further, by controlling the rotation speed of the first rotation motor 223a, the rotation speed of the first rotation disk 221a and the driving ball 210 may be controlled. Further, as aforementioned, the angle adjuster 20 may be supplied with power through the main body 10 or may be supplied with power through a directly connected power cable provided to receive external power, through which the first rotation motor 223a may also be supplied with driving power.

Further, the second rotation unit 220b and the third rotation unit 220c may include the same components as the first rotation unit 220a, and the second rotation unit 220b may include a second rotation disk 221b, a second rotation axis 222b and a second rotation motor 223b, and the third rotation unit 220c may include a third rotation disk 221c, a third rotation axis 222c and a third rotation motor 223c.

Further, the rotation of the first to third rotation disk 221a, 221b, 221c may be driven by a single rotation motor or by a gear and the like that transmits driving force to each of the first to third rotation disk 221a, 221b, 221c.

As aforementioned, the driving ball 210 is supported by the capsule member 250 in a state where a portion thereof is surrounded by the capsule member 250, and thus the capsule member 250 may include a plurality of contact holes 251 formed in positions corresponding to the rotation unit 220 so that the driving ball 210 contacts the plurality of rotation units 220 without being covered by the capsule member 250.

For example, the capsule member 250 may include a first contact hole 251a formed in a position facing the first rotation unit 220a so that the first rim 2210a of the first rotation unit 220a and the outer surface of the driving ball 210 of which a portion is surrounded by the capsule member 250 may contact each other.

Specifically, in an inner space of the first contact hole 251a, the first rim 2110a of the first rotation disk 221a and the outer surface of the driving ball 210 may contact each other, and accordingly, the driving ball 210 may receive rotary force from the first rotation disk 221a and rotate.

Further, the first contact hole 251a may be formed to have a minimum size in which the first rim 2110a of the first rotation disk 221a may contact the outer surface of the driving ball 210. Accordingly, it is possible to increase the surface area of the capsule member 250 that supports the driving ball 210, and thus the driving ball 210 may rotate stably inside the capsule member 250.

Further, just as the first contact hole 251a regarding the first rotation unit 220a, the capsule member 250 may include a second contact hole 251b and a third contact hole 251c each formed in a position to which the second rotation disk 221b and the third rotation disk 221c and the driving ball 210 correspond.

FIG. 4 is a plan view of the example angle adjuster 20 illustrated in FIG. 3, and for convenience of explanation regarding the structure of arrangement of the first to third rotation unit 220a, 220b, 220c and the driving ball 210, only the driving ball 210 and the connection member 240, and the first to third rotation disk 221a, 221b, 221c in a state contacting the driving ball 210 are illustrated, and further, only the portion of the display 11 coupled to the connection member 240 is illustrated in dotted lines.

As aforementioned, the first to third rotation unit 220a, 220b, 220c may be disposed at certain intervals around the driving ball 210.

Referring to FIG. 3 and FIG. 4, in a state where each of the first to third rotation unit 220a, 220b, 220c is disposed below the center point of the driving ball 210, each of the first to third rotation disk 221a, 221b, 221c may contact a lower side of the outer surface of the driving ball 210.

Specifically, each of the first to third rotation disk 221a, 221b, 221c may include a first to third rim 2210a, 2210b, 2210c, and each of the first to third rim 2210a, 2210b, 2210cmay rotate in a state where they each contact the outer surface of the driving ball 210, thereby rotating the driving ball 210 in various angles.

Further, each of the first to third rotation disk 221a, 221b, 221c may be coupled to the first to third rotation axis 222a, 222b, 222c, and the first to third rotation axis 222a, 222b, 222c may be disposed such that they are not parallel to one another. Therefore, each of the first to third rotation disk 221a, 221b, 221c may contact the outer surface of the driving ball 210 in a state where they are each tilted by a certain angle from the ground.

For example, the first to third rotation disk 221a, 221b, 221c may be disposed at identical intervals on an identical plane at the lower side of the driving ball 210, and as illustrated in FIG. 4, the first to third rotation disk 221a, 221b, 221c may be arranged radially, and thus arranged on a vertex of triangle.

More specifically, when contact points at which the first to third rim 2210a, 2210b, 2210c of the first to third rotation disk 221a, 221b, 221c contact the driving ball 210 are connected to one another, a regular triangle may be formed.

Further, as illustrated in FIG. 3, by configuring the angles at which the first to third rotation axis 222a, 222b, 222c are tilted from the ground to be identical, the rotating direction and angle of the driving ball 210 may be adjusted with precision.

Accordingly, each of the first to third rotation disk 221a, 221b, 221c may be rotated in different directions from one another, and by combining the rotary force that the first to third rotation disk 221a, 221b, 221c apply to the driving ball 210, it is possible to rotate the driving ball 210 in various directions.

In order to control the rotary force being applied from the first to third rotation disk 221a, 221b, 221c to the driving ball 210, the angle adjuster 20 may include the moving unit 230 that is capable of changing the position of the rotation unit 220.

Specifically, the moving unit 230 may move each of the first to third rotation unit 220a, 220b, 220c, and may selectively move each of the first to third rotation disk 221a, 221b, 221c to a contact position contacting the driving ball 210 or to a spaced position spaced apart from the driving ball 210.

As illustrated in FIG. 3, the moving unit 230 may be plural, including a first to third moving unit 230a, 230b, 230c each coupled to the first to third rotation unit 220a, 220b, 220c, respectively.

Each of the first to third moving unit 230a, 230b, 230c may include a first to third driver 231a, 231b, 231cand a first to third moving axis 232a, 232b, 232c, respectively.

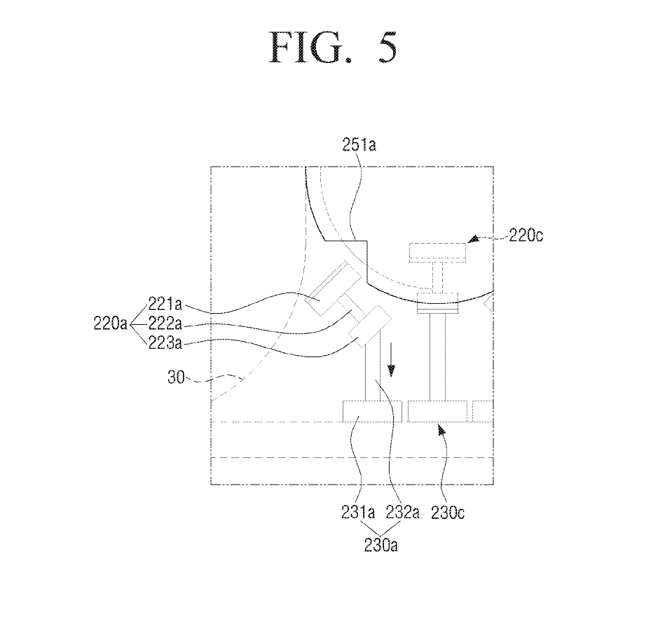

FIG. 5 is a view illustrating where the first rotation unit 220a is moved downwards to a spaced position spaced apart from the driving ball 210 by the first moving unit 230a.

The components of the first to third moving unit 230a, 230b, 230c are identical to one another, and thus hereinbelow, the structure and functions of the moving unit 230 will be explained with reference to the first moving unit 230a, and explanation on the second and third moving unit 230b, 230c that overlaps with the first moving unit 230a will be omitted.

One end of the first moving axis 232a may be coupled to the first rotation motor 223a of the first rotation unit 220a, and the other end of first moving axis 232a that is opposite to the one end coupled to the first rotation motor 223a may be coupled to a first driver 231a.

The first driver 231a may include a solenoid valve, a linear motor, a cylinder and the like, and may raise or lower the first moving axis 232a along a longitudinal direction of the first moving axis 232a.

Further, as aforementioned, the angle adjuster 20 may be supplied with power through the main body 10, or may be directly connected to a separate power cable configured to receive power from outside, and accordingly, the first driver 231a may also be supplied with driving power.

Referring to FIG. 3 and FIG. 5, as the first rotation unit 220a is lowered by the first moving unit 230a, the first rotation disk 221a may be moved to a spaced position spaced apart from the driving ball 210, and as the first rotation unit 220a is raised again by the first moving unit 230a, the first rotation disk 221a may move to a contact position contacting the driving ball 210.

Further, the second and third moving unit 230b, 230c may also raise or lower the second and third rotation unit 220b, 220c that they are coupled to, respectively, thereby selectively moving each of the second and third rotation disk 221b, 221c of the second and third rotation unit 220b, 220c to one of a contact position contacting the driving ball 210 and a spaced position spaced apart from the driving ball 210.

Accordingly, the first to third rim 2210a, 2210b, 2210c of the first to third rotation disk 221a, 221b, 221c may selectively contact the outer surface of the driving ball 210, thereby selectively applying rotary force to the driving ball 210. Therefore, the rotation unit of the first to third rotation unit 220a, 220b, 220c that moved to the spaced position may not transmit rotary force to the driving ball 210, and thus the rotation motor of the rotation unit disposed in the spaced position may be stopped from driving through the controller 130.

Further, although it was explained with reference to FIG. 3 and FIG. 5, that the first to third moving unit 230a, 230b, 230c each raise or lower the first to third rotation unit 220a, 220b, 220c through the first to third moving axis 232a, 232b, 232c as an example, the first to third moving unit 230a, 230b, 230c may move the first to third rotation unit 220a, 220b, 220c to any one of the contact position and the spaced position by moving the first to third rotation unit 220a, 220b, 220c to the left or right side, and besides the aforementioned, the first to third moving unit 230a, 230b, 230c may selectively move the first to third rotation unit 220a, 220b, 220c to any one of the contact position and the spaced position through various motion routes.

Accordingly, since the first to third moving unit 220a, 220b, 220c disposed at certain intervals around the driving ball 210 selectively contact the driving ball 210 through the first and third moving unit 230a, 230b, 230c, rotary force is selectively applied to the driving ball 210, and thus it is possible to adjust the rotating direction of the driving ball 210 in various ways.

Further, by varying the rotation speed of each rotation disk 221 contacting the driving ball 210 and applying rotary force to the driving ball 210 to be different from one another, or by separately adjusting the rotating direction of each rotation disk 221, it is possible to change the rotating direction of the driving ball 210 in various ways, and accordingly, the rotating direction and the angle of the main body 10 may be adjusted in various ways according to the user's gaze. Operations for rotating the driving ball 210 in various ways will be explained in detail later on.

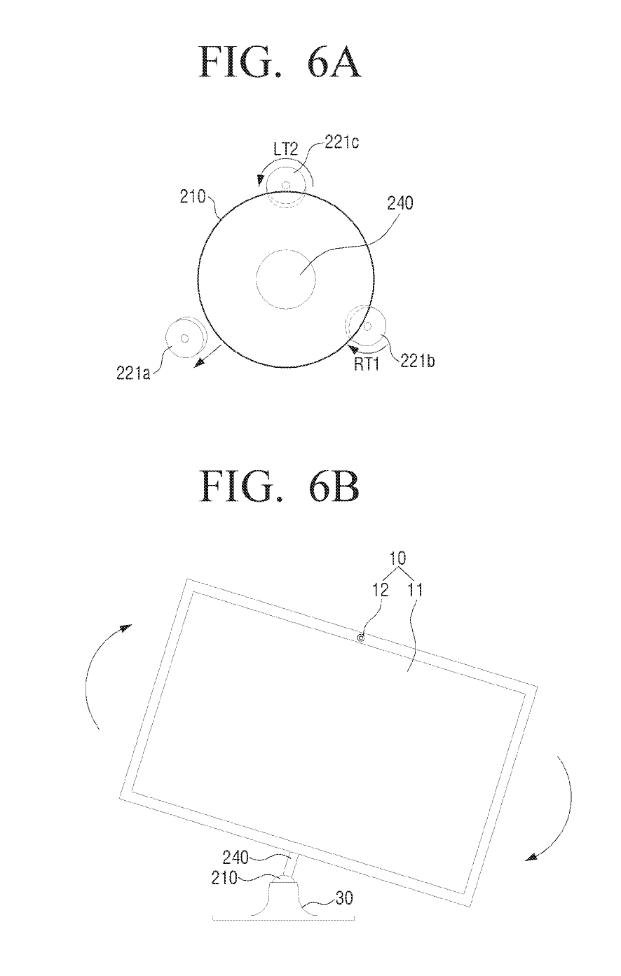

FIGS. 6A, 6B, 7A, 7B, 8A, 8B, 9A, 9B, 10A, 10B, 11A and 11B are views illustrating the main body 10 rotated in various directions according to driving of the angle adjuster 20 according to an example embodiment of the present disclosure. In FIGS. 6A to 11B, for convenience of explanation, the driving ball 210 and the first to third rotation disk 221, 221b, 221c applying rotary force to the driving ball 210 are illustrated, and also how the angle of the main body 10 of the display apparatus 1 is adjusted accordingly.

Hereinbelow, with reference to FIGS. 6A to 11B, explanation will be made on angle adjustments of the main body 10 by various driving methods of the angle adjuster 20. Further, hereinbelow, explanation will be made on rotations or directions in which the main body 10 is tilted with reference to the front surface where the content image of the display apparatus 1 is displayed.

Further, for convenience of explanation, the first to third rotation disk 221a, 221b, 221c rotated by a certain angle in a clockwise direction will be defined as a first clockwise direction rotation RT1, the first to third rotation disk 221a, 221b, 221c rotated in a clockwise direction at a speed that is twice the speed of the first clockwise direction rotation RT1 will be defined as a second clockwise direction rotation RT2, the first to third rotation disk 221a, 221b, 221crotated by an angle identical to the first clockwise direction rotation RT1 in a counterclockwise direction will be defined as a first counterclockwise direction rotation LT1, and the first to third rotation disk 221a, 221b, 221c rotated in a counterclockwise direction at a speed that is twice that of the first counterclockwise direction rotation LT1 will be defined as a second counterclockwise direction rotation LT2.

FIG. 6A is a view illustrating driving of the first to third rotation disk 221a, 221b, 221c, and FIG. 6B is a front view illustrating a state where the main body 10 is tilted to the right side according to FIG. 6A.

Specifically, as illustrated in FIG. 6A, the first to third rotation disk 221a, 221b , 221c disposed at certain intervals at a lower side of the driving ball 210 may rotate the driving ball 210 to the right side, thereby tilting the main body 10 to the right side.

For this purpose, in a state where the second and third rotation disk 221b, 221c are disposed in a contact position, the second and third rotation disk 221b, 221c may simultaneously apply rotary force to the driving ball 210, and the first rotation disk 221a may be disposed in a spaced position, thereby not applying rotary force to the driving ball 210. Therefore, as the first rotation unit 220a is lowered by the first moving unit 230a, the first rotation disk 221a may move to a spaced position spaced apart from the outer surface of the driving ball 210.

Further, as the second rotation disk 221b makes a first clockwise direction rotation RT1, and the third rotation disk 221c makes a second counterclockwise direction rotation LT2, the driving ball 210 may rotate in a right direction, and accordingly, the main body 10 may be tilted to a right side.

The second rotation disk 221b and the third rotation disk 221c may have different rotation speeds and directions, and as the rotary force of the second and third rotation disk 221b, 221c in such a state is simultaneously transmitted to the driving ball 210, by the combination of the rotary force of the second and third rotation disk 221b, 221c, the driving ball 210 may be tilted to a right side.

Further, as the driving ball 210 rotates by a desired angle to a right side, when the main body 10 turns into a state where it is tilted to a right side by a desired degree, the second and third rotation disk 221b, 221c stop, and the first rotation disk 221a that had moved to the spaced position may be moved back to the contact position by the first moving unit 230a. Accordingly, as the first to third rotation disk 221a, 221b, 221c support the outer surface of the driving ball 210, the position of the main body 10 that is in a state tilted to the right side may be firmly fixated.

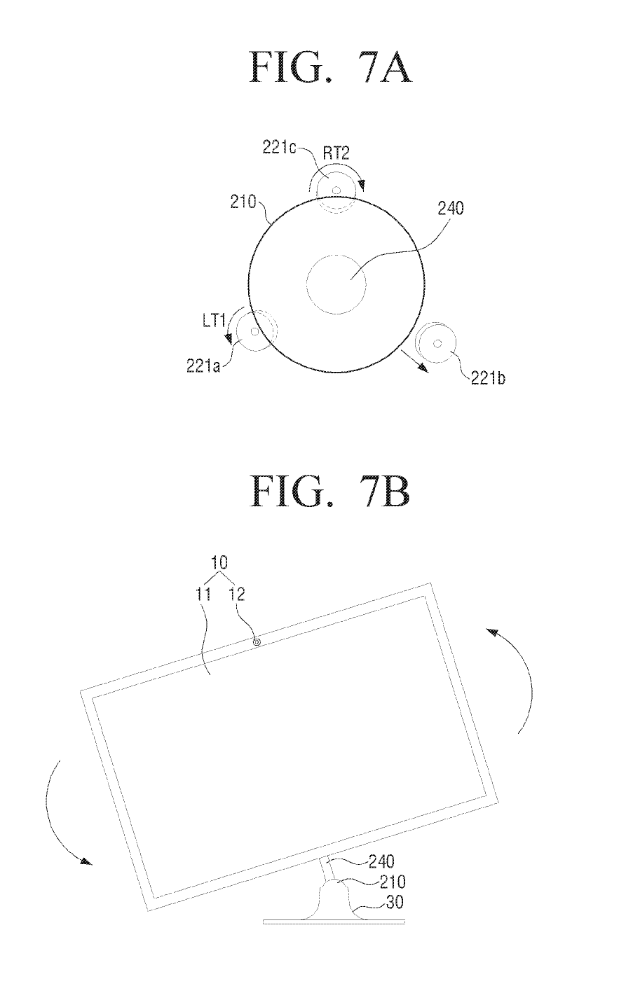

Hereinbelow, with reference to FIGS. 7A to 11B, a method for adjusting the angle of the main body 10 in a direction different from that in FIGs. 6A and 6B will be explained, with a main focus on the differences from the angle adjustment of the main body 10 in FIGS. 6A and 6B, and explanation overlapping with that of FIGS. 6A and 6B will be omitted.

FIG. 7A is a view illustrating driving of the first to third rotation disk 221a, 221b, 221c, and FIG. 7B is a front view illustrating a state where the main body 10 is tilted to a left side according to FIG. 7A.

As illustrated in FIG. 7A, in a state where the first and third rotation disk 221a, 221c are disposed in a contact position, the first and third rotation disk 221a, 221c may simultaneously apply rotary force to the driving ball 210, and the second rotation disk 221b may be disposed in a spaced position, thereby not applying rotary force to the driving ball 210. Therefore, as the second rotation unit 220b is lowered by the second moving unit 230b, the second rotation disk 221b may move to a spaced position spaced apart from the outer surface of the driving ball 210.

Further, as the first rotation disk 221a makes a first counterclockwise direction rotation LT1 and the third rotation disk 221c makes a second clockwise direction rotation RT2, the driving ball 210 may rotate in a left direction, and accordingly, the main body 10 may be tilted to a left side.

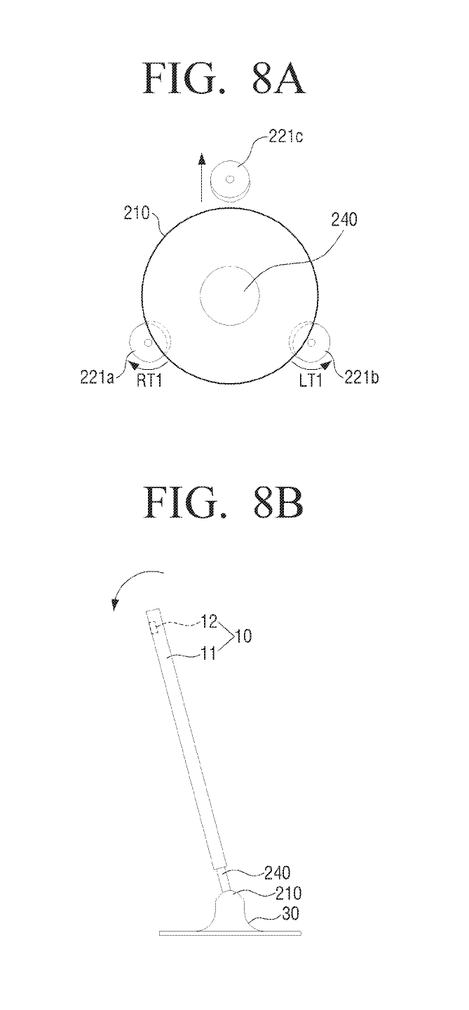

FIG. 8A is a view illustrating driving of the first to third rotation disk 221a, 221b, 221c, and FIG. 8B is a right side view illustrating a state where the main body 10 is tilted to a front direction according to FIG. 8A.

As illustrated in FIG. 8A, in a state where the first and second rotation disk 221a, 221b are disposed in a contact position, the first and second rotation disk 221a, 221b may simultaneously apply rotary force to the driving ball 210, and as the third rotation disk 221c is disposed in a spaced position, the third rotation disk 221c may not apply rotary to the driving ball 210. Therefore, as the third rotation unit 220c is lowered by the third moving unit 230c, the third rotation disk 221b may move to a spaced position spaced apart from the outer surface of the driving ball 210.

Further, as the first rotation disk 221a makes a first clockwise direction rotation RT1 and the second rotation disk 221b makes a first counterclockwise direction rotation LT1, the driving ball 210 may rotate in a front direction, and accordingly, the main body 10 may be tilted towards the front direction.

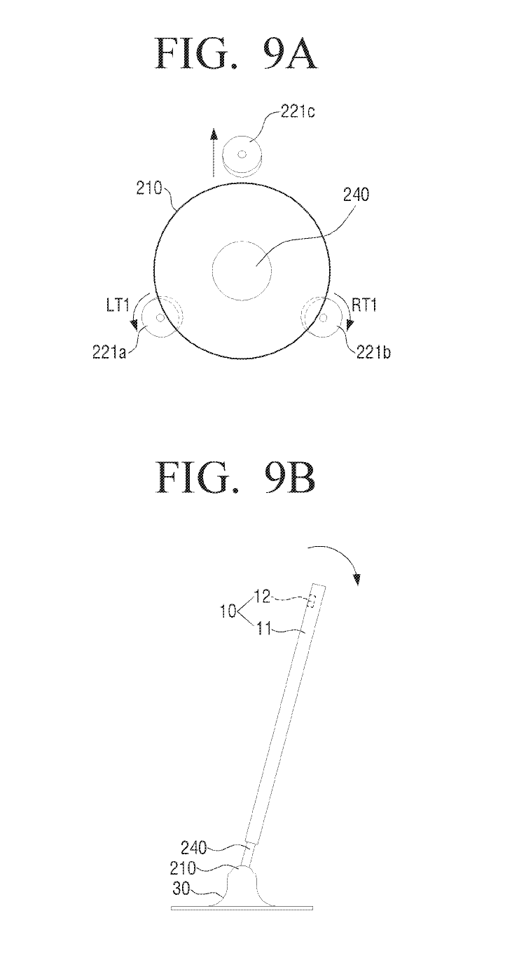

FIG. 9A is a view illustrating driving of the first to third rotation disk 221a, 221b, 221c, and FIG. 9B is a right side view illustrating a state where the main body 10 is tilted in a rear direction according to FIG. 9A.

As illustrated in FIG. 9A, in a state where the first and second rotation disk 221a, 221b are disposed in a contact position, the first and second rotation disk 221a, 221b simultaneously apply rotary force to the driving ball 210, and as the third rotation disk 221c is disposed in a spaced position, the third rotation disk 221c may not apply rotary force to the driving ball 210. Therefore, as the third rotation unit 220c is lowered by the third moving unit 230c, the third rotation disk 221b may move to a spaced position spaced apart from the outer surface of the driving ball 210.

Further, as the first rotation disk 221a makes a first counterclockwise direction rotation LT1 and the second rotation disk 221b makes a first clockwise direction rotation RT1, the driving ball 210 may rotate in a rear direction, and accordingly, the main body 10 may be tilted towards the rear direction.

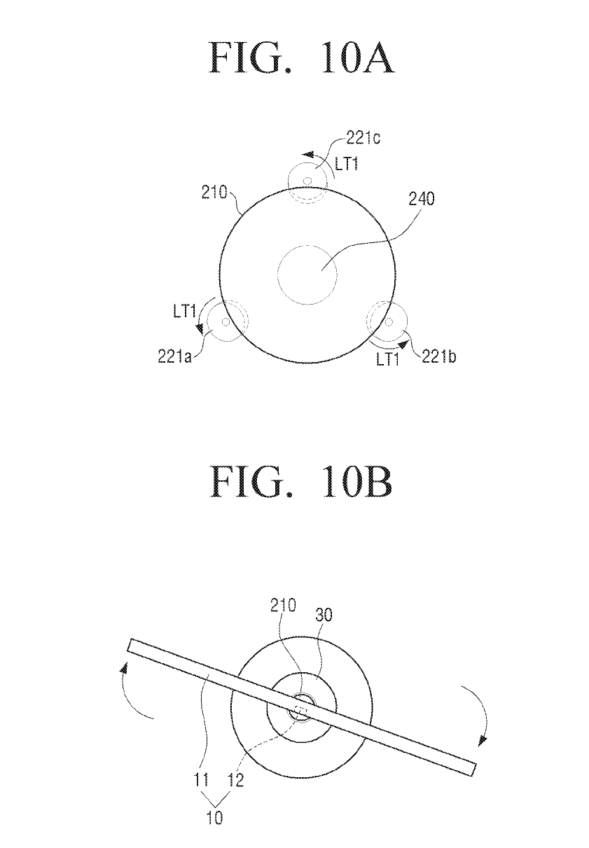

FIG. 10A is a view illustrating driving of the first to third rotation disk 221a, 221b, 221c, and FIG. 10B is a plan view illustrating the main body 10 rotating to a clockwise direction according to FIG. 10A.

As illustrated in FIG. 10A, in a state where the first to third rotation disk 221a, 221b, 221c are disposed in a contact position, the first to third rotation disk 221a, 221b, 221c may simultaneously apply rotary force to the driving ball 210, and as the first to third rotation disk 221a, 221b, 221c simultaneously rotate in a first counterclockwise direction LT1, the driving ball 210 may rotate in a clockwise direction, and accordingly, the main body 10 may rotate in a clockwise direction.

The first to third rotation disk 221a, 221b, 221c may rotate in an identical direction at an identical speed, thereby rotating the main body 10.

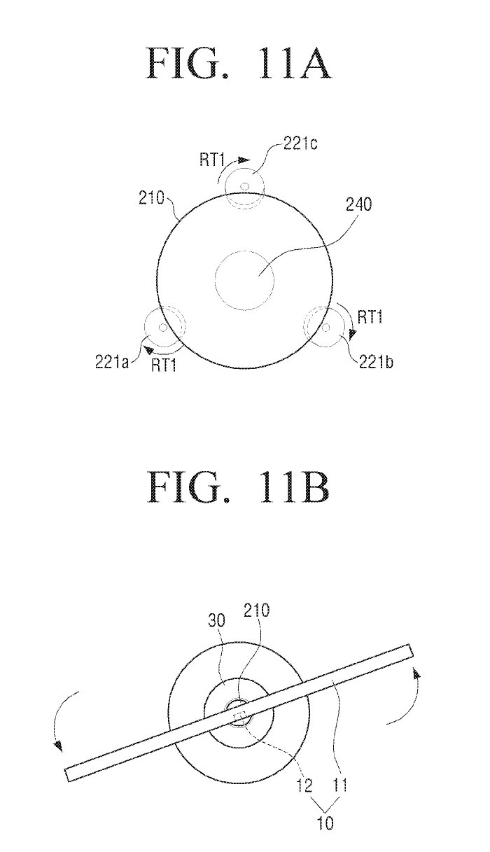

FIG. 11A is a view illustrating driving of the first to third rotation disk 221a, 221b, 221c, and FIG. 11B is a plan view illustrating the main body 10 rotating in a counterclockwise direction according to FIG. 11A.

As illustrated in FIG. 11A, in a state where the first to third rotation disk 221a, 221b, 221c are disposed in a contact position, the first to third rotation disk 221a, 221b, 221c simultaneously apply rotary force to the driving ball 210, as the first to third rotation disk 221a, 221b, 221c simultaneously rotate in a first clockwise direction RT1, the driving ball 210 may rotate in a counterclockwise direction, and accordingly, the main body 10 may rotate in a counterclockwise direction.

Although it was explained with reference to FIGS. 6A to 11B that by combination of rotary force of the first to third rotation disk 221a, 221b, 221c, the main body 10 is tilted to a front, rear, left, and right side, or rotated in a clockwise direction or in a counterclockwise direction as an example, by changing the combination of the rotary force of the plurality of rotation disks in various ways, the rotating direction of the driving ball 210 may be adjusted in various ways, and accordingly, the angle of the main body 10 may also be changed in various ways.

Further, by rotating the driving ball 210 in various angles through selective combinations of the rotary force of the first to third rotation unit 220a, 220b, 220c, the angle adjuster 20 may adjust the angle of the main body 10, and thus the angle adjustment of the main body 10 may be made smoothly sequentially.

Further, the user's gaze may be detected through the camera 12 of the main body 10, and according to the user's gaze, the first to third rotation unit 220a, 220b, 220c may automatically rotate the driving ball 210 through the controller 13, and thus it is possible to adjust the angle of the main body 10 smoothly in real time in response to changes of the user's gaze. Accordingly, even when the user moves or changes his/her posture and thus the user's gaze changes sequentially, the main body 10 may automatically adjust the angle in response to the user's gaze. Accordingly, the user may not only easily recognize the content image being displayed through the display 11, but as the angle adjustment of the main body 10 is made smoothly sequentially, the user may also easily recognize the content image even during the angle adjustment of the main body 10.

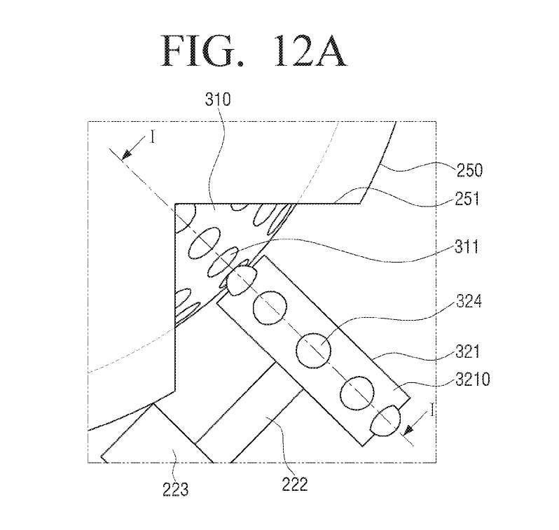

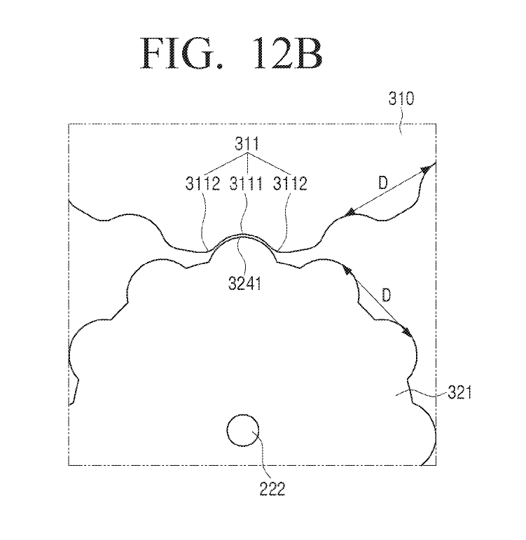

FIG. 12A is an enlarged view of the driving ball 310 and the rotation disk 321 of the angle adjuster 20 according to another example embodiment of the present disclosure, and FIG. 12B is a view illustrating a cross-sectional view of the driving ball 310 and the rotation disk 321 cut along line I-I shown in FIG. 12A.

The rotation disk 321 according to another example embodiment of the present disclosure may be configured in plural, and be disposed at certain intervals around the driving ball 310, but FIG. 12A and FIG. 12B illustrate enlarged views of only one rotation disk 321.

Referring to FIG. 12A and FIG. 12B, the driving ball 310 according to another embodiment of the present disclosure may include a plurality of driving grooves 311 formed on the outer surface of the driving ball 310, and include a plurality of driving projections 324 in the rim 3210 of the rotation disk 321.

An interval D at which the plurality of driving projections 324 are disposed may be identical to an interval D at which the plurality of driving grooves 311 are disposed so that the plurality of driving projections 324 may each be inserted into and withdrawn from each of the plurality of driving grooves 311.

Accordingly, as the rotation disk 321 rotates, the plurality of driving projections 324 may be inserted into and withdrawn from the plurality of driving grooves 311, and the rotary force of the rotation disk 321 may be effectively transmitted to the driving ball 310.

Further, since the driving ball 310 may be rotated as the plurality of driving projections 324 are inserted into and withdrawn from the plurality of driving grooves 311, rotation of the driving ball 310 may not only be manipulated with precision, but in fixating the main body 10 that is in a tilted state, as the driving projection 324 is coupled to the driving groove 311, the main body 10 may also be fixated stably.

Further, as illustrated in FIG. 12B, each of the plurality of driving projections 324 may include a first curved surface 3241, and each of the plurality of driving grooves 311 may include a second curved surface 3111 and a third curved surface 3112 that surrounds the second curved surface 3111.

Further, a curvature of the first curved surface 3241 may be configured to be identical to a curvature of the second curved surface 3111, and a curvature of the third curved surface 3112 may be configured to be smaller than a curvature of the first curved surface 3241. Accordingly, the first curved surface 3241 and the second curved surface 3111 may contact each other, and the first curved surface 3141 and the third curved surface 3112 may be spaced apart from each other. Therefore, the driving projection 324, in a state where it is inserted into the driving groove 311, may contact a portion of the driving groove 311.

Accordingly, the driving projection 324 may be easily inserted into the driving groove 311, and may be easily withdrawn from the driving groove 311.

Therefore, as the rotation disk 321 rotates, the plurality of driving projections 324 may be inserted into and withdrawn from the plurality of driving grooves 311 sequentially, thereby rotating the driving ball 310, and as the plurality of driving projections 324 may be easily inserted into or withdrawn from the plurality of driving grooves 311, the plurality of rotation disks 321 may easily simultaneously transmit rotary force to the driving ball 310.

Hereinabove, FIG. 12B illustrated an enlarged view of only a portion of the plurality of driving projections and the plurality of driving grooves for convenience of explanation, but each configuration and number of the plurality of driving projections and the driving grooves may vary.

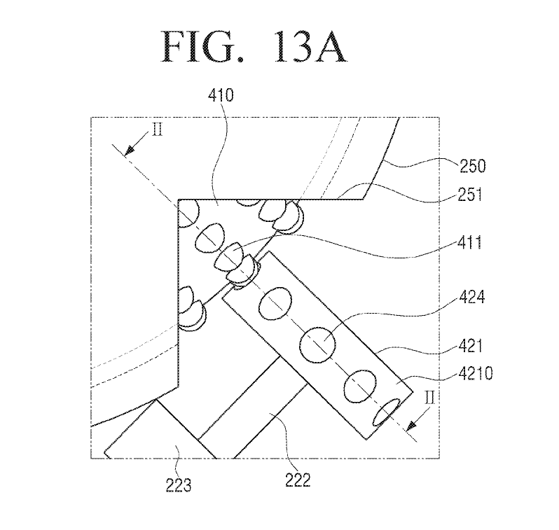

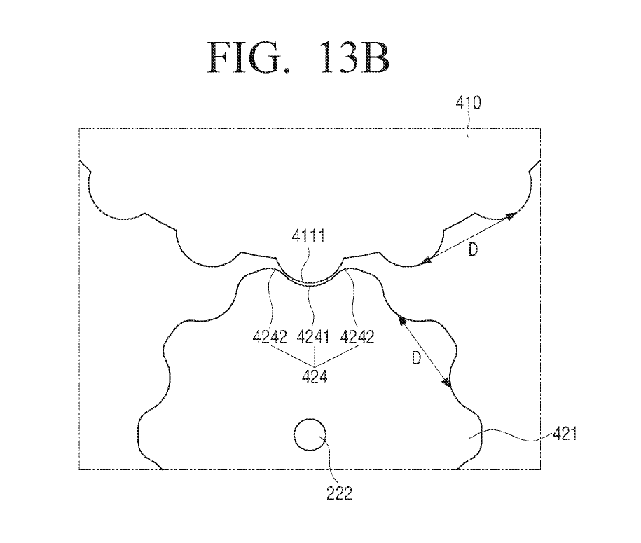

FIG. 13A illustrates an enlarged view of the driving ball 410 and the rotation disk 421 of the angle adjuster 20 according to another example embodiment of the present disclosure, and FIG. 13B is a cross-sectional view of the driving ball 410 and the rotation disk 421 cut along line II-II shown in FIG. 13A.

The rotation disk 421 according to another example embodiment of the present disclosure may be configured in plural and be disposed at certain intervals around the driving ball 410, but FIGS. 13A and FIG, 13B illustrate only enlarged views of one rotation disk 421 for convenience of explanation.

Referring to FIG. 13A and FIG. 13B, the driving ball 410 according to another embodiment of the present disclosure may include a plurality driving projections 411 formed on the outer surface of the driving ball 410, and a plurality of driving grooves 424 formed in the rim 4210 of the rotation disk 421.

An interval D at which the plurality of driving projections 411 are arranged may be identical to an interval D at which the plurality of driving grooves 424 are arranged so that the plurality of driving projections 411 may each be inserted into and withdrawn from each of the plurality of driving grooves 424.

Accordingly, as the rotation disk 421 rotates, the plurality of driving projections 411 may be inserted into and withdrawn from the plurality of driving grooves 424, and the rotary force of the rotation disk 421 may be effectively transmitted to the driving ball 410.

Further, since the driving ball 410 may be rotated as the plurality of driving projections 411 are inserted into and withdrawn from the plurality of driving grooves 424, rotation of the driving ball 410 may not only be manipulated with precision, but in fixating the main body 10 that is in a tilted state, as the driving projection 411 is coupled to the driving groove 424, the main body 10 may be fixated stably.

Further, as illustrated in FIG. 13B, each of the plurality of driving projections 411 may include a first curved surface 4111, and each of the plurality of driving grooves 424 may include a second curved surface 4241 and a third curved surface 4242 that surrounds the second curved surface 4241.

Further, a curvature of the first curved surface 4111 may be configured to be identical to a curvature of the second curved surface 4241, and a curvature of the third curved surface 4242 may be configured to be smaller than a curvature of the first curved surface 4111. Accordingly, the first curved surface 4111 and the second curved surface 4241 may contact each other, and the first curved surface 4111 and the third curved surface 4242 may be spaced apart from each other. Therefore, the driving ball 411, in a state where it is inserted into the driving groove 424, may contact a portion of the driving groove 424.

Accordingly, the driving projection 411 may not only be easily inserted into the driving groove 424, and but may also be easily withdrawn from the driving groove 424.

Therefore, as the rotation disk 421 rotates, the plurality of driving projections 411 may be inserted into and withdrawn from the plurality of driving grooves 424 sequentially, thereby rotating the driving ball 410, and as the plurality of driving projections 411 may be easily inserted into or withdrawn from the plurality of driving grooves 424, the plurality of rotation disks 421 may easily simultaneously transmit rotary force to the driving ball 410.

Hereinabove, FIG. 13B illustrated an enlarged view of only a portion of the plurality of driving projections and the plurality of driving grooves for convenience of explanation, but each configuration and number of the plurality of driving projections and the driving grooves may vary.

Further, besides the method where the plurality of driving projections 411 of the driving ball 410 are inserted into and withdrawn from the plurality of driving grooves 424 of the rotation disk 421 so that the rotary force of the rotation disk 421 is effectively transmitted to the driving ball 410, the rotation disk 421 of the rotation unit may include a rotatable chain structure that may be locked to the plurality of driving projections 411, in which case, as the chain structure of the rotation unit rotates, the plurality of driving projections 411 may be inserted into and withdrawn from the chain structure sequentially, thereby rotating the driving ball 410.

Besides the above, the structure and shape of the plurality of driving projections and the driving grooves may vary, and the configuration of the rotation unit that may rotate the driving ball may also vary.

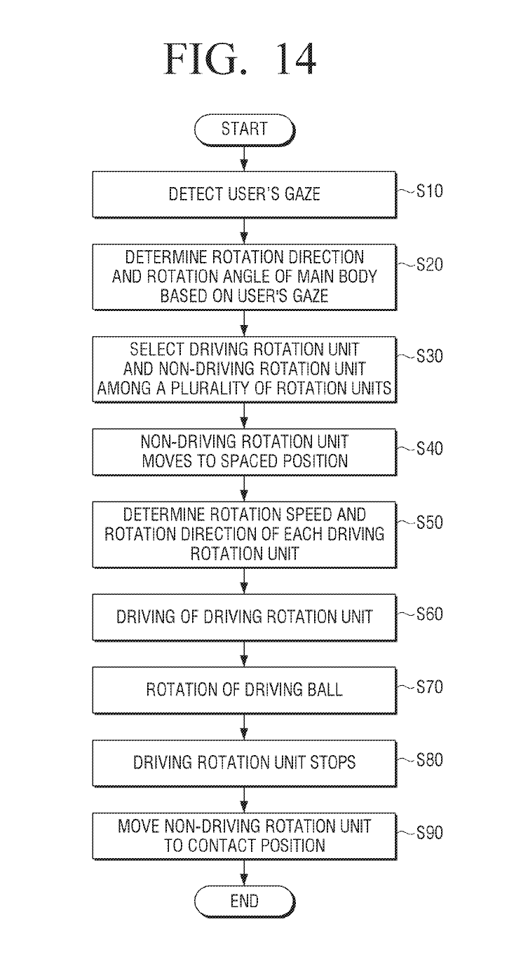

FIG. 14 is a flowchart illustrating an example process according to an example embodiment of the present disclosure where an angle of the main body 10 is automatically adjusted based on the user's gaze by driving of the angle adjuster 20 of the display apparatus 1.

Referring to FIG. 14, a method for driving the display apparatus 1 according to an embodiment of the present disclosure may include a step of detecting a user's gaze (S10), a step of determining a rotating direction and a rotating angle of the main body 10 based on the user's gaze (S20), selecting a driving rotation unit and remaining rotation units as non-driving rotation units from a plurality of rotation units 220 (S30), moving the non-driving rotation unit to a spaced position (S40), determining a rotation speed and a rotating direction of each of the driving rotation unit (S50), driving the driving rotation unit (S60), rotating the driving ball 210 (S70), stopping the rotation of the driving rotation unit (S80), and moving the non-driving rotation unit to a contact position (S90).

Each step of the method of driving the display apparatus 1 mentioned above will be explained based on an assumption that they proceed in the order described, for the sake of convenience of explanation, but the order of the steps may be changed or the steps may proceed simultaneously, or a certain step may be repeated or omitted.

First of all, the user may turn ON an automatic adjustment mode that is configured such that an angle of the display apparatus 1 is automatically adjusted according to a user's gaze through a separate remote control apparatus (not illustrated) or an inputter (not illustrated) of the display apparatus 1.

Then, the camera 12 of the main body 10 may detect the user's gaze and photograph the same (S10), and transmit information on the user's gaze to the controller 13, and the controller 13 may determine a direction and an angle and the like of the user's gaze based on the information on the user's gaze, and determine a rotating direction and a rotating angle and the like of the main body 10 that allows the user's gaze and the main body 10 to face each other 10 (S20).

Further, in the case where a plurality of users are looking at the front surface of the display apparatus 1, the controller 13 may select one representative user and control the angle adjuster 20 according to a gaze of the representative user, and further, the controller 13 may allow the users to select the representative user among the plurality of users through a content image.

When the rotating direction and the rotating angle and the like of the main body 10 are determined based on the information on the user's gaze, from the plurality of rotation units 220, the controller 13 selects the driving rotation unit for applying rotary force to the driving ball 210 in a contact position contacting the driving ball 210, and selects the remaining rotation units as the non-driving rotation units for moving to a spaced position spaced from the driving ball 210 so as not to apply rotary force to the driving ball 210 (S30).

Selecting the driving rotation unit and the non-driving rotation unit from the plurality of rotation units 210 may be made automatically by the controller 13 according to the determination regarding the rotating direction and the rotating angle of the main body 10. Further, according to the rotating direction and the rotating angle and the like of the main body 10, a plurality of driving rotation units may be selected, and a plurality of non-driving rotation units may be selected as well.

Then, the non-driving rotation unit may be moved to a spaced position by the moving unit (S40), thereby being disposed in a position where it may not apply rotary force to the driving ball 210.

After the non-driving rotation unit is moved to the spaced position, the rotation speed and the rotating direction of each of the driving rotation unit are determined (S50).

This may be determined automatically by the controller 13 according to the determination regarding the rotating direction and the rotating angle of the main body 10, and the controller 13 may transmit an operation command such that each of the plurality of driving rotation units rotates in different directions or at different speeds from one another.

Accordingly, each of the driving rotation unit may rotate separately (S60), and as the rotary force of the driving rotation unit is transmitted to the driving ball 210, the driving ball 210 may rotate (S70).

Rotation of the driving ball 210 by the driving rotation unit may be made in various angles and directions by combinations of the rotary force of the plurality of driving rotation units as aforementioned with reference to FIGS. 6A to 11B, and accordingly, the angle of the main body 10 may also be adjusted in various directions.

When the driving ball 210 is rotated in a predetermined angle and direction by the controller 13, the driving rotation unit stops rotating (S80), thereby fixating the position of the driving ball 210.

Then, the non-driving rotation unit that used to be disposed in a spaced position and thus in a spaced state from the driving ball 210 may be moved back to the contact position by the moving unit (S90). Accordingly, to the driving ball 210 that completed rotation, all the plurality of rotation units 220 may be disposed in a contact position, thereby contacting the driving ball 210. Therefore, as the plurality of rotation units 220 support the driving ball 210, the driving ball 210 may be fixated without rotating further, and accordingly, the main body 10 with an adjusted angle may be fixated.

As aforementioned, the each step of the method for angle adjustment of the main body 10 may proceed at the same time, and some of the orders of the steps may be changed or omitted. Further, detecting the user's gaze and adjusting the angle of the main body 10 may reflect the information on the user's gaze in real time, and may thus respond to the movement of the user's gaze in real time, and accordingly the angle adjuster 20 may adjust the angle of the main body 10 in real time.

Further, as the angle of the main body 10 is adjusted by the smooth rotation of the sphere-shaped driving ball 210, even when the angle of the main body 10 is adjusted while the user is looking at a content image of the main body 10, the user may view the content image comfortably without a sense of difference of the content image that the user may otherwise feel.

Hereinabove, explanation is based on an example embodiment where the controller and the camera and the like are configured inside the main body 11, for convenience of explanation, but according to various modifications, such configurations may be provided at the side of the angle adjuster 20 or the stand housing 30 instead of the main body 11. Further, some of those configurations may be provided separately outside the display apparatus 1, and perform wired or wireless communication with the display apparatus 1 to perform the aforementioned operations. For example, in the case where at least one external camera is connected to the display apparatus 1, the display apparatus 1 may determine the user's gaze using images photographed by the external camera and perform the aforementioned operations.

Further, although explanation was made with reference to the aforementioned example embodiments based on the case of analyzing a user's gaze and operating the display apparatus 1 accordingly, in modified embodiments, only the user's position may be analyzed and not the user's gaze to drive the display apparatus 1.

The various example embodiments aforementioned were explained separately, but each of the example embodiments may not necessarily be realized separately, and the configuration and operation of each of the example embodiments may be realized in combinations with at least one other example embodiment.

The foregoing example embodiments and advantages are merely examples and are not to be understood as limiting the present disclosure. The present teaching can be readily applied to other types of apparatuses. Also, the description of the example embodiments of the present disclosure is intended to be illustrative, and not to limit the scope of the claims, and many alternatives, modifications, and variations will be apparent to those skilled in the art.

What is claimed is:

1. A display apparatus comprising:
a main body including a display configured to display an image;
an angle adjusting apparatus configured to rotate the main body and comprises a substantially sphere-shaped driving ball configured to support the main body; and
at least one rotation apparatus configured to rotate the driving ball with reference to a center point of the driving ball.

2. The display apparatus according to claim 1,
wherein the at least one rotation apparatus includes a plurality of rotation apparatuses each configured to apply rotary force to the driving ball to rotate the driving ball in directions different from one another,
and the plurality of rotation apparatuses each include a rotation axis not parallel to one another.

3. The display apparatus according to claim 2,
wherein the plurality of rotation apparatuses each comprise a rotation disk configured to rotate with reference to the rotation axis in a state where rotation disk is in contact with the driving ball,
each rotation disk comprises a rim contacting an outer surface of the driving ball, and
the driving ball is configured to rotate by friction force against the rim.

4. The display apparatus according to claim 3,
wherein the rim comprises a plurality of driving projections protruding outwardly from the rim, and
the outer surface of the driving ball includes a plurality of driving grooves configured to respectively receive the plurality of driving projections.

5. The display apparatus according to claim 4,
wherein the driving projection is configured to contact a portion of the driving groove in a state where the driving projection is inserted into the driving groove.

6. The display apparatus according to claim 5,
wherein each of the plurality of driving projections includes a first curved surface,
each of the plurality of driving grooves includes a second curved surface configured to contact the first curved surface and a third curved surface substantially surrounding the second curved surface, and
a curvature of the first curved surface being substantially identical to a curvature of the second curved surface, and the curvature of the first curved surface is greater than a curvature of the third curved surface.

7. The display apparatus according to claim 3,
wherein the outer surface of the driving ball includes a plurality of driving projections protruding outwardly from the driving ball, and
the rim includes a plurality of driving grooves configured to respectively receive the plurality of driving projections.

8. The display apparatus according to claim 7,
wherein the driving projection is configured to contact a portion of the driving groove in a state where the driving projection is inserted into the driving groove.

9. The display apparatus according to claim 8,
wherein each of the plurality of driving projections includes a first curved surface,
each of the plurality of driving grooves includes a second curved surface configured to contact the first curved surface and a third curved surface that substantially surrounds the second curved surface, and
a curvature of the first curved surface is substantially identical to a curvature of the second curved surface, and the curvature of the first curved surface is greater than a curvature of the third curved surface.

10. The display apparatus according to claim 2,
wherein the angle adjuster includes a plurality of moving units each coupled to a respective one of the plurality of rotation units, and
each moving unit is configured to move a corresponding rotation unit to a contact position contacting the driving ball and a spaced position spaced apart from the driving ball.

11. The display apparatus according to claim 10,
wherein, the rotation unit disposed in the spaced position does not apply rotary force to the driving ball.

12. The display apparatus according to claim 10,
wherein the plurality of rotation units disposed in the contact position rotate at different speeds from one another.

13. The display apparatus according to claim 1,
wherein the angle adjuster includes a capsule surrounding at least a portion of the driving ball, and
the driving ball is configured to rotate inside the capsule.

14. The display apparatus according to claim 13,
wherein the capsule includes at least one contact hole formed at a position corresponding to the at least one rotation unit, and
the rotation unit is configured to contact the driving ball inside the contact hole.

15. The display apparatus according to claim 14,
wherein the driving ball includes a connection member having one end configured to be coupled to the driving ball and another end configured to be coupled to the main body,
the capsule comprising an opening that includes the one end of the connection member disposed inside the opening, and
a diameter of the opening is greater than a diameter of the one end of the connection member.

16. The display apparatus according to claim 1,
wherein the main body includes a camera; and
a controller configured to detect a user's gaze from a user's image photographed by the camera, and to control a rotation of the driving ball wherein the detected user's the gaze and the main body face each other.
